(19) United States
(12) Patent Application Publication
(10) Pub. No.: US 2005/0014496 A1
(43) Pub. Date: Jan. 20, 2005

(54) Method and apparatus for adaptive and online assignment in hierarchical overlay networks

(76) Inventors: Seung-Jae Han, Basking Ridge, NJ (US); Thierry E. Klein, Westfield, NJ (US)

Correspondence Address: Docket Administrator (Room 3J-219);Lucent Technologies Inc., 101 Crawfords Corner Road, Holmdel, NJ, 07733-3030, US

(21) Appl. No.: 10/619,046

(22) Filed: Jul. 14, 2003

(51) Int. Cl. H04Q 7/20

(52) U.S. Cl. 455/423; 455/444; 455/67.11

(57) ABSTRACT

A method and apparatus is disclosed for calculating a threshold used to assign a data transmission from a user to one layer in a plurality of layers in a wireless communications network. A balancing metric is calculated for one layer in the network as a function of a characteristic of the user's data transmission. This balancing metric is then calculated for a second layer in the network, also as a function of the characteristic of the user's transmission. A threshold is then adjusted in response to the value of the first balancing metric relative to the second balancing metric. Data users are then assigned to a layer in the network based on a comparison of the threshold to the value of the characteristic for that user.

### FIELD OF THE INVENTION

The present invention relates to wireless communications systems and, more specifically, to user assignment strategies in hierarchical data overlay networks.

### BACKGROUND OF THE INVENTION

Wireless communications systems are becoming an increasingly integral aspect of modern communications. Some of the major challenges facing next-generation wireless networks lay in efficient resource allocation and mobility management strategies that can accommodate a large number of high-data-rate users. Hierarchical or multi-tier network architectures which, for example, have a macro-cell layer and a micro-cell layer, have recently been proposed for these applications.

In such two-tier, hierarchical networks, assignment strategies for assigning different users to different tiers have to date been tailored towards voice users and circuit-switched services, with the objective of reducing the probability of service blocking or call dropping. These assignment strategies, which are well known in the art, have focused on the velocities of mobile users relative to the center of a micro-cell or macro-cell, and micro-cell and macro-cell traversal times relative to handoff and switching times. Such assignment strategies are appropriate for voice users, who have fixed throughput rates and bounded data-delay requirements, and whose call arrival and call length processes conform to particular statistical models.

However, data users, while in some cases requiring more aggregate bandwidth than voice users, are generally more flexible with respect to delay and minimum continuous data rate requirements, and their usage patterns exhibit different statistical distributions compared to voice users. For example, email communications are much less sensitive to delays and interruptions in transmission than are voice communications. Internet access and file transfers, likewise, can tolerate a bursty communications channel, as long as reasonable response times and reasonable average throughputs are maintained. Further, due to increased buffering typically available on data devices relative to voice devices, and due to the substantially unidirectional nature of the communications, even streaming data applications exhibit a greater robustness to data interruptions than do voice communications.

In order to address the differences between a data transmission and a voice transmission, one recent attempt at user assignment took into account data characteristics of transmissions or, alternatively, data characteristics coupled with velocity characteristics of transmissions. This attempt is described in commonly-assigned copending U.S. patent application Ser. No. 10/411844, filed Apr. 11, 2003, titled “User Assignment Stratgegies For Hierarchical And Other Overlay Networks,” having the same inventors as the present application (“'844 application”). This application describes an assignment system that made assignment decisions to different layers in a communication network for both voice and data users by taking into account the different characteristics of such users' transmissions.

### SUMMARY OF THE INVENTION

The inventors have now recognized that assignment strategies that are appropriate for voice users may be inefficient and/or inadequate for next generation wireless networks that support both voice and data users. Specifically, the present inventors have realized that it is advantageous to use an assignment method for users transmitting data that is not necessarily based on the same assignment criteria used for assigning users transmitting voice messages. While the '844 application is useful in many regards, the calculations required by the assignment strategies developed in accordance with the teachings of that application were relatively intensive and complex.

The present inventors have invented a more efficient, less complex method and apparatus for calculating a transmission characteristic threshold used in an assignment strategy to assign a data transmission from a user to one layer in a plurality of layers in a wireless communications network. Specifically, a balancing metric is calculated for one layer in the network as a function of a characteristic of the user's data transmission. This balancing metric is then calculated for a second layer in the network, also as a function of the characteristic of the user's transmission. A transmission characteristic threshold is then adjusted in response to the value of the first balancing metric relative to the second balancing metric. Data users are assigned to a layer in the network based on a comparison of the adjusted threshold to the value of the characteristic for that user. The method and apparatus of the present invention does not require excessively complex calculations and, as a result, can be made on-line in near-real-time to adjust the assignment strategy adaptively to accommodate the changing needs of users.

### BRIEF DESCRIPTION OF THE DRAWING

FIG. 1 shows an exemplary hierarchical network and assignment controller according to one embodiment of the present invention;

FIG. 2 shows an exemplary implementation of a hierarchical assignment manager in the network of FIG. 1; and

FIG. 3 shows a flow diagram illustrating the operation of the hierarchical assignment manager of FIG. 2.

### DETAILED DESCRIPTION OF THE INVENTION

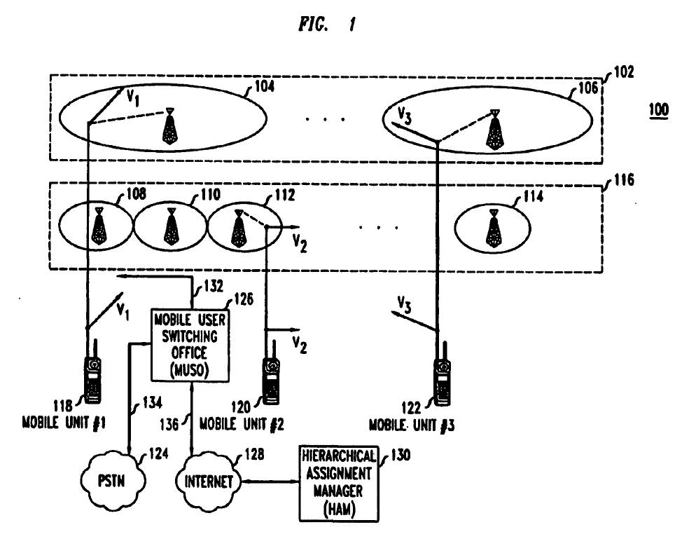

FIG. 1 shows an exemplary hierarchical network with a hierarchical assignment manager (HAM) 130 according to one embodiment of the present invention. For simplicity, a network of only two layers is illustrated; however, one skilled in the art will recognize that such a network may be extended to three or more layers. The two layers depicted are referred to as the macro-cell layer and the micro-cell layer. The macro-cell layer 102 contains one or more macro-cells (e.g., macro-cells 104 and 106) that are typically configured for coverage of a geographical region. The micro-cell layer 116 contains one or more micro-cells (e.g., micro-cells 108, 110, 112, and 114) that are typically used to provide high throughput in local high-usage areas (i.e., areas where high usage is expected or has been experienced, for example, in and around airports, malls, traffic hubs, and convention centers).

FIG. 1 also depicts mobile unit 118, mobile unit 120, and mobile unit 122 that transmit and receive data over the micro-cell layer or the macro-cell layer. At an instant in time, for example, mobile unit 118 has velocity v₁, is assigned to macro-cell 104, and has, illustratively, a quantity Dᵣ₁ of data to transmit. Mobile unit 120 has velocity v₂, is assigned to micro-cell 112, and has, illustratively, a quantity of data Dᵣ₂ to transmit. Finally, mobile unit 122 has velocity v₃, is assigned to macro-cell 106, and has, illlustratively, a quantity of data Dᵣ₃ to transmit.

The macro-cells and micro-cells are centered on cell sites, each of which includes transceiver equipment to support the wireless users (e.g., mobile users 118, 120 and 122) that are assigned to that cell. The macro-cells and micro-cells are linked to mobile user switching office (MUSO) 126 (links not shown), which provides connectivity for voice calls to/from public switched telephone network (PSTN) 124 and connectivity for data calls to/from a private data network via illustrative communication link 132 or the public Internet 128 via illustrative communication link 136 . Internet 128 also provides connectivity between illustrative mobile users 118,122 and 122 and hierarchical assignment manager (HAM) 130 . HAM 130 functions to assign a user data transmission to one of the layers in the hierarchical network, here either the micro-cell layer 116 or the macro-cell layer 102 . One skilled in the art will recognize that HAM 130 may be part of or co-hosted at MUSO 126, or located or distributed at any other location throughout the network and/or base stations.

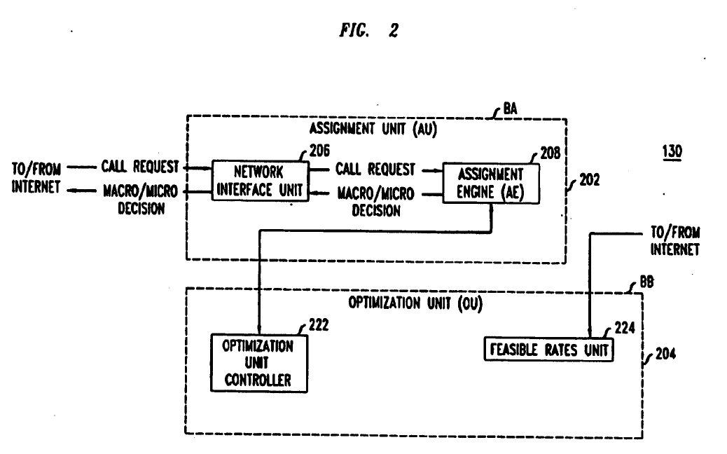

FIG. 2 shows one illustrative implementation of HAM 130 in FIG. 1. Specifically, FIG. 2 depicts two illustrative components of HAM 130, the assignment unit (AU) 202 and optimization unit (OU) 204 . The AU 202 handles the dynamic assignment of users to the macro-cell layer or the micro-cell layer in the system based on a calculated transmission characteristic threshold, while the OU 204 processes transmission data and generates metrics used in the determination of the above-referenced threshold that is used by the AU in the dynamic assignment decision. The calculation of the metrics and threshold by the OU, discussed further below, can be accomplished periodically or in near-real-time, such as illustratively every 1-5 minutes. Those skilled in the art will realize that different timeframes may be utilized for such calculations.

AU 202 includes network interface unit 206, which interfaces the assignment with the Internet, thereby providing connectivity between the AU and mobile subscribers via the mobile user switching office 126 in FIG. 1. Call requests from mobile users, which include information related to a desired user transmission characteristic, such as velocity and/or the size of data to be transmitted, are received by network interface unit 206 and passed to assignment engine 208 for processing. To make assignment decisions, assignment engine (AE) 208 makes use of a transmission characteristic threshold for the desired user transmission characteristic, such as, for example, a specific velocity threshold, that is calculated by the optimization unit. If the desired characteristic of a transmission by a particular user falls below this threshold (e.g., the user is traveling slower than the threshold velocity) then the transmission from that user will be assigned to one layer of the network (e.g., to a micro-cell). If, on the other hand, the user transmission characteristic is above the threshold (e.g., the user is traveling faster than the threshold velocity), then the transmission from that user will be assigned to a second layer of the network (e.g., to a macro-cell). The assignment result of the AE (e.g., either a macro- or a micro-cell) is communicated to the mobile user via network interface unit 206 and also optionally stored, along with other identifying information, in a user database in mobile user switching office 126 for the purpose of maintaining the layer assignment through a low-level handoff.

As discussed previously, OU 204 calculates certain metrics to generate a transmission characteristic threshold that is used by the AU 202 in assigning a user to a particular layer in the network. In one embodiment in accordance with the principles of the present invention, these calculations are dependent upon the type of assignment system used in the network. For example, in a velocity assignment system (VAS), the OU 204 calculates a velocity threshold to be used to determine when a user is to be assigned to a particular layer in the network. Alternatively, in a data assignment system (DAS), the OU 204 calculates a data criterion threshold (such as, illustratively, a data size threshold) to be used to determine when a user is to be assigned to a particular layer. Ideally, the calculated threshold will be such that, when the threshold is used to make assignment decisions, there is an optimal balance in system usage between the different layers of the network such as, here, the macro-cell layer and the micro-cell layer.

For any assignment system, for example either a VAS or DAS—based system, in order to determine whether an optimal balance exists between the different system layers, a particular goal based on an operating characteristic of the system layers must be established. For example, in any assignment system, the operating characteristic may be the average number of users in the system and, thus, the goal may be to minimize this average number of users. This particular goal will allow users to transmit over the minimum necessary time and then to exit the system, thereby freeing available resources for the remaining users or any new incoming users. Alternatively, another operating characteristic for such systems could be the expected system load seen by a new user to the system and, thus, the goal may be to minimize this expected system load. This goal will give each new user the best assignment to a particular layer that minimizes the total number of bits of information to be transmitted cumulatively for all users (i.e., the number of users multiplied by the number of bits each user has to transmit) when the new user's data requirements are taken into account. The above two operating characteristics used to develop goals for assigning users to a layer in a network are merely illustrative in nature. One skilled in the art will recognize that any relevant operating characteristic used to develop such goals to make assignment strategies will work equally as well.

The balance at any given time between, for example, the macro-cell layer and the micro-cell layer can be measured through the use of a balancing metric to determine whether there is a system balance between the two different layers. This balancing metric is directly related to the particular operating characteristic to be achieved (e.g., the average number of users in the system or the expected system load seen by a new user to the system).

In one illustrative embodiment in accordance with the principles of the present invention, an assignment system is selected wherein the performance goal of the assignment system is to minimize the average number of users in the system. The average number of users in the system can be defined by the expression:
E[N_{sys}]=E[Nₘ]+E[N_{μ}] (1)
where E[N_{sys}] is the average number of users in the system, E[Nₘ] is the average number of users in the macro-cell layer, and E[N_{μ}] is the average number of users in the micro-cell layer. As is apparent from equation 1, in order to minimize the average number of users in the system E[Nₘ] and E[N_{μ}] should be adjusted in a way such that the sum of the terms E[Nₘ] and E[N_{μ}] is minimized.

To accomplish this adjustment, where the goal is to minimize the average number of users, the goal of a balancing metric used to compare the macro- and micro cell layers can be written as:
Xₘ=X_{μ} (2A)
where:

$$\begin{matrix}{X}_{m} = \frac{{C}_{m} - {λ}_{m} {\overline{D}}_{m}}{\sqrt{{C}_{m}}} and & ( 2 B ) \\ {X}_{μ} = \frac{{C}_{μ} - {λ}_{μ} {\overline{D}}_{μ}}{\sqrt{{C}_{μ}}} & ( 2 C )\end{matrix}$$

In equations 2A, 2B and 2C, Cₘ is the cell capacity of the macro-cell layer (i.e., the total cell throughput at the macro cell), λₘ is the call arrival rate after assignment of the user to the macro-cell, C_{μ} is the cell capacity of the micro-cell layer (i.e., the total cell throughput at the micro cell), and λ_{μ} is the call arrival rate after assignment of the user to the micro cell, Xₘ is the balancing metric for the macro-cell layer, X_{μ} is the balancing metric for the micro-cell layer, \overline{D}ₘ is the average data size of the users in the macro-cells; \overline{D}_{μ} is the average data size of the users in the micro-cells; and the expression

$$\frac{{C}_{x} - {λ}_{x} {\overline{D}}_{x}}{\sqrt{{C}_{x}}}$$

is the balancing metric for exemplary layer “x” in the network. In a DAS system, \overline{D}ₘ is defined by the expression

$${\overline{D}}_{m} = \frac{{λ}_{1} {\int }_{{D}_{min}}^{{D}_{0}} ⅆ {f}_{D} ( ⅆ ) ⅆ ⅆ + {λ}_{2} E [ D ]}{{λ}_{m}}$$

and \overline{D}_{μ} is defined by the expression

$${\overline{D}}_{μ} = \frac{{λ}_{1} {\int }_{{D}_{0}}^{{D}_{max}} ⅆ {f}_{D} ( ⅆ ) ⅆ ⅆ}{{λ}_{μ}} .$$

Similarly, in a VAS system, \overline{D}ₘ is defined by the expression \overline{D}ₘ=E[D] and \overline{D}_{μ} is defined by the expression \overline{D}_{μ}=E[D] where E[D] is the average data size of all users in the user population.

In equations 2A-2C, C_{μ} and Cₘ are independent of the assignment strategy, however λₘ and λ_{μ} are dependent upon the particular assignment strategy used (e.g., VAS or DAS) and can be defined as a function of the aggregate call arrival rates in the system prior to any assignment decision. Such aggregate rates are experienced by the micro-cell layer in the network (denoted herein as rate of calls λ₁) and the macro-cell layer in the network (denoted herein as rate of calls λ₂). The use of these aggregate rates is necessary as some of the calls counted in the rate λ₁ in the micro-cell will not be assigned to the micro-cell layer but will, instead, be assigned to the macro-cell layer. Thus, it can be stated that, dependent in part on the aggregate data rates λ₁ and λ₂ assignment decisions are made between the two layers of the network and, accordingly, the post-assignment data rates λₘ and λₘ are achieved in the micro- and macro-cell layers. Thus, λ_{μ} and λₘ in equations 2B and 2C (which represent the rate of calls actually assigned to the micro-cell and the macro-cell layers, respectively) can be more particularly defined as:
λ_{μ}=λ₁q_{μ} (3)
and
λₘ=λ₂+λ₁qₘ (4)
where q_{μ} is the probability that a user meets the criteria for assignment to the micro-cell layer and qₘ is the probability that a user meets the criteria for assignment to the macro-cell layer.

As mentioned above, λ_{μ} and λₘ are dependent upon the assignment system used. In particular, this dependency is reflected in the calculations of the probabilities q_{μ} and qₘ, which differ depending upon the assignment strategy. Specifically, in a VAS-based system, qₘ and q_{μ} can be calculated as:

$$\begin{matrix}{q}_{m} = {\int }_{v = {V}_{0}}^{{V}_{max}} {\int }_{d = {D}_{min}}^{{D}_{max}} {f}_{V , D} ( v , ⅆ ) ⅆ v ⅆ ⅆ = {\int }_{v = {V}_{0}}^{{V}_{max}} {f}_{V} ( v ) ⅆ v and & ( 5 ) \\ {q}_{μ} = {\int }_{v = {V}_{min}}^{{V}_{0}} {\int }_{d = {D}_{min}}^{{D}_{max}} {f}_{V , D} ( v , ⅆ ) ⅆ v ⅆ ⅆ = {\int }_{v = {V}_{min}}^{{V}_{0}} {f}_{V} ( v ) ⅆ v & ( 6 )\end{matrix}$$

where d is the data to be transmitted by a user, Dₘᵢₙ is the minimum data amount to be transmitted by any user in the user population, Dₘₐₓ is the maximum data amount to be transmitted by a user, v is the velocity of a user, Vₘᵢₙ is the minimum velocity in the user population, Vₘₐₓ is the maximum velocity in the user population, and V₀ is the velocity threshold above which a user is assigned to a particular layer in the system (i.e., here, illustratively, users with average velocity V>V₀ are assigned to the macro layer to minimize hand-offs). In a DAS-based system, on the other hand, q_{μ} and qₘ can be calculated as:

$$\begin{matrix}{q}_{m} = {\int }_{d = {D}_{min}}^{{D}_{0}} {\int }_{v = {V}_{min}}^{{V}_{max}} {f}_{V , D} ( v , ⅆ ) ⅆ v ⅆ ⅆ = {\int }_{d = {D}_{min}}^{{D}_{0}} {f}_{D} ( ⅆ ) ⅆ ⅆ and & ( 7 ) \\ {q}_{μ} = {\int }_{d = {D}_{0}}^{{D}_{max}} {\int }_{v = {D}_{min}}^{{V}_{max}} {f}_{V , D} ( v , ⅆ ) ⅆ v ⅆ ⅆ = {\int }_{d = {D}_{0}}^{{D}_{max}} {f}_{D} ( ⅆ ) ⅆ ⅆ & ( 8 )\end{matrix}$$

where the variables are defined as in the VAS system above and D₀ is the data size threshold above which a user is assigned to a particular layer in the system (i.e., here, illustratively, users whose amount of data D>D₀ are assigned to the micro layer due to the inherently larger capacity of micro cells relative to macro cells).

Thus, equations 3-8 above provide calculations that are necessary to determine both sides of the balancing metric of equation 2A. If the side of equation 2A representing the macro-cell layer (i.e., Xₘ) is larger than the side representing the micro-cell layer (i.e., X_{μ}) then, illustratively, the threshold at which a user is assigned to the macro-cell layer will be appropriately modified (e.g., in a VAS-based system, the velocity at which a user will be assigned to the macro-cell layer will be raised, and in a DAS-based system, the data size at which a user will be assigned to the macro-cell layer will be lowered). The converse will occur if X_{μ} is higher than Xₘ (i.e., the result being that the threshold for assigning to the macro-cell layer will be lowered in a VAS system and raised in a DAS system).

It follows that, in accordance with the principles of the present invention, a threshold can be determined at which balance is achieved according to equation 2A (i.e., the threshold at which the two sides of equation 2A are equal). This threshold is referred to herein as the optimal threshold. In a system where the goal is to minimize the average number of users in a DAS-based system, the optimal data size threshold can be determined by:

$${\int }_{{D}_{min}}^{{D}_{0}^{*}} {xf}_{D} ( x ) ⅆ x = \frac{{C}_{m} \sqrt{{C}_{μ}} - {C}_{μ} \sqrt{{C}_{m}} - ( {λ}_{2} \sqrt{{C}_{μ}} - {λ}_{1} \sqrt{{C}_{m}} ) E [ D ]}{{λ}_{1} ( \sqrt{{C}_{m}} + \sqrt{{C}_{μ}} )} \qquad ( 9 )$$

and in a VAS-based system, the optimal velocity threshold can be determined by:

$${\int }_{{V}_{min}}^{{V}_{0}^{*}} {f}_{V} ( x ) ⅆ x = \frac{( {λ}_{1} + {λ}_{2} ) E [ D ] \sqrt{{C}_{μ}} - {C}_{m} \sqrt{{C}_{μ}} + {C}_{μ} \sqrt{{C}_{m}}}{( \sqrt{{C}_{m}} + \sqrt{{C}_{μ}} ) {λ}_{1} E [ D ]} \qquad ( 10 )$$

In equations 9 and 10 the variables are defined as set forth above, while D₀* is the optimal data threshold constrained to be within the interval [Dₘᵢₙ, Dₘₐₓ] and V₀* is the optimal velocity threshold constrained to be within the interval [Vₘᵢₙ, Vₘₐₓ]. E[D] is, once again, the average data size of all users in the user population in the macro-cell layer and the micro-cell layer combined. Accordingly, the optimal data threshold D₀* and/or the optimal velocity threshold V₀* in a DAS and VAS system, respectively, can be calculated to permit optimal assignment of users to macro- and micro-cell layers in a network. Thus, balance is achieved between those macro- and micro-cell layers.

The above discussion considered one embodiment in accordance with the principles of the present invention whereby the goal of an assignment system, either VAS or DAS-based, was to minimize the average number of users in the network. As discussed previously, one skilled in the art will recognize that many alternate goals may be used in the effort to achieve optimal performance of a chosen assignment system. One such alternate goal, in another embodiment in accordance with the principles of the present invention, is to minimize the expected system load as seen by a new, incoming user to be assigned to one of the macro- or micro-cell layers in a network. The expected system load is defined herein as the average number of bits in the network awaiting transmission when a new call from the user arrives in at the network. Such an expected system load is defined as:
E[L_{sys}]=Pr(m)\overline{D}ₘE[Nₘ]+Pr(μ)\overline{D}_{μ}E[N_{μ}] (11)
where E[L_{sys}] is the expected system load; Pr(m) and Pr(μ) are the probabilities that a user is assigned to the macro and the micro-cell layers, respectively; E[Nₘ] and E[N_{μ}] are the average number of users in the macro- and the micro cells, respectively; and \overline{D}_{μ} and \overline{D}ₘ are the average amounts of data to be transmitted by users assigned to the macro- and the micro-cells, respectively.

In such a case, the goal of the balancing metric can once again be calculated by equation 2A with:

$$\begin{matrix}{X}_{m} = \frac{{λ}_{m} {\overline{D}}_{m}}{{C}_{m} - {λ}_{m} {\overline{D}}_{m}} . \\ and & ( 12 ) \\ {X}_{μ} = \frac{{λ}_{μ} {\overline{D}}_{μ}}{{C}_{μ} - {λ}_{μ} {\overline{D}}_{μ}} . & ( 13 )\end{matrix}$$

However, one skilled in the art will recognize that

$$\frac{{λ}_{m} {\overline{D}}_{m}}{{C}_{m} - {λ}_{m} {\overline{D}}_{m}}$$

is merely equal to E[Nₘ], the average number of users in the macro-cell layer. Similarly,

$$\frac{{λ}_{μ} {\overline{D}}_{μ}}{{C}_{μ} - {λ}_{μ} {\overline{D}}_{μ}}$$

is equal to E[N_{μ}], the average number of users in the micro-cell layer. Therefore, the balancing metric for the goal of minimizing the expected system load can be expressed with Xₘ=E[Nₘ] and X_{μ}=E[N_{μ}]. This balancing equation has the benefit that the average number of users over a given amount of time in both the macro- and micro-cell layers is readily available and no a priori knowledge of cell capacities is required.

It follows that, in accordance with the principles of the present invention, when the goal of an assignment system is to minimize the expected system load, the optimum data size threshold D₀*in a DAS-based system can be determined by:

$${\int }_{{D}_{min}}^{{D}_{0}^{*}} {xf}_{D} ( x ) ⅆ x = \frac{( {λ}_{1} {C}_{m} - {λ}_{2} {C}_{μ} ) E [ D ]}{{λ}_{1} ( {C}_{m} + {C}_{μ} )} \qquad ( 14 )$$

such that balance is achieved according to the above balancing equation, E[Nₘ]=E[N_{μ}]. In a VAS-based system, balance in this equation can be achieved by calculating the optimal velocity threshold V₀* as:

$${\int }_{{V}_{min}}^{{V}_{0}^{*}} {f}_{V} ( x ) ⅆ x = \frac{( {λ}_{1} + {λ}_{2} ) {C}_{μ}}{{λ}_{1} ( {C}_{m} + {C}_{μ} )} . \qquad ( 15 )$$

The variables in equations 14 and 15 are defined as set forth herein above. Once again, in equation 14, D₀* is constrained to be within the interval [Dₘᵢₙ, Dₘₐₓ] and, in equation 15, V₀* is constrained to be within the interval [Vₘᵢₙ, Vₘₐₓ]

The discussion above has thus far centered on determining an optimum data size threshold and an optimum velocity threshold to assign users to a network layer in a DAS-based system or a VAS based system, respectively. Two different illustrative system goals (out of many possible such goals) were considered: minimum average number of users in the system and minimum expected system load. While the optimum data size and velocity thresholds of equations 9, 10, 14 and 15 are useful, they each require a certain amount of a priori information relating to the system in order to calculate the optimum values. Specifically, these equations each require knowledge of the macro- and micro-cell capacities, the profile distribution of velocity and data size across the user population, and the call arrival rates. Unfortunately, in practical systems, such knowledge may not be available and, thus, would have to be estimated.

Estimations would be difficult as the information to be estimated would frequently be time-varying and, therefore, the only practical method of performing such calculations would be to accomplish those calculations in an off-line manner (i.e., not in sufficient time to perform an update to the optimal threshold and assign a new user to a network layer).

The present inventors have realized that it is a desirable goal of an assignment system to not make such estimations and to assign users in an on-line manner to a network layer in real-time or in a near-real-time fashion. Therefore, in accordance with the principles of the present invention, such equations that do not require estimation can be obtained by holding the calculated optimum thresholds constant over a given period of time. This is possible because the thresholds are not likely to vary significantly over a short period of time (e.g., less than a minute). The calculated optimum thresholds are only updated at the beginning of each update interval. Therefore, the goal of the balancing metric as expressed in equation 2A can be expressed as:
Xₘ[k]=X_{μ}[k] (16)
where Xₘ[k] and X_{μ}[k] represent the values of the balancing metric at the macro- and micro-cell layers at the beginning of the k-th update interval. At the beginning of that interval, the optimal threshold (either data size or velocity) is updated in proportion to any imbalance that exists between the values of Xₘ[k] and X_{μ}[k].

In accordance with such an updating method, in a VAS-based system the optimal velocity threshold is updated according to:

$${V}_{0} [ k ] = min \{ max \{ {V}_{min} , {V}_{0} [ k - 1 ] + \frac{{β}_{v}}{{k}^{{γ}_{v}}} [ {X}_{m} [ k ] - {X}_{μ} [ k ] ] \} , {V}_{max} \} \qquad ( 17 )$$

where V₀[k] is the optimal velocity threshold at the k-th update interval; β_{ν} is an update magnitude parameter that can be tuned in order to regulate the speed of convergence of the algorithm; γ_{ν} is a time discounting factor which results in the algorithm making smaller adjustments as the number of updates performed is increased (and hence as the velocity threshold becomes closer to the intended value); and V₀[k−1] is the velocity threshold used at the k−1 update interval. The term

$$\frac{{β}_{v}}{{k}^{{γ}_{v}}}$$

guarantees convergence of the update algorithm and avoids limit cycles (i.e., bouncing back and forth repeatedly between two values of the threshold, neither one of which is the optimal threshold) by making smaller incremental changes to the velocity threshold. One skilled in the art will recognize that variables such as β_{ν} and γ_{ν} may take many forms and, accordingly, one skilled in the art will be able to devise different values and/or expressions that will be suitable for use in those variables.

If the calculation for both the macro- and micro-cell layers leads to the result that Xₘ[k]>X_{μ}[k], there are too many users assigned to the macro-cell layer, resulting in an imbalance in favor of the micro-cell layer. Hence, the optimal velocity threshold should be adjusted in such a way as to increase the number of users in the micro-cell (i.e., V₀ should be increased). Similarly, if Xₘ[k]<X_{μ}[k], V₀ should be decreased. One skilled in the art will recognize that the updated value of V₀[k] obtained via equation 17 is constrained to be in the interval [Vₘᵢₙ, Vₘₐₓ].

While the optimal velocity threshold of equation 17 is useful, a potential drawback to this equation is that it may be very sensitive to the measurements taken in the last update interval k−1. Thus, in accordance with the principles of the present invention, a “smoother” update rule, that considers the exponentially weighted moving average of the difference in the balancing metric, may be used. Such a rule is considered smoother as it is not as sensitive to the measurements taken in the previous update interval. The exponentially weighted moving average of the difference in the balancing metric may be expressed as:
Δ[k]=(1−α_{ν})[Xₘ[k]−X_{μ}[k]]+α_{ν}·Δ[k−1] (18)
where Δ[k] is the weighted moving average, Xₘ[k] is the balancing metric for the macro-cell layer at the k-th update interval, X_{μ}[k] is the balancing metric for the micro-cell layer at the k-th update interval, α_{ν} is a smoothing factor where α_{ν}∈[0,1], and Δ[k−1] is the previously calculated weighted moving average at the k−1 update interval. The term α_{ν} can be chosen, or tuned, to give more or less weight to the past measurements.

The resulting optimal velocity threshold update taking into account the weighted average of equation 18, and thus being less sensitive to instantaneous changes in the balancing metric from previous updates, can be expressed as:

$${V}_{0} [ k ] = min \{ max \{ {V}_{min} , {V}_{0} [ k - 1 ] + \frac{{β}_{v}}{{k}^{{γ}_{v}}} Δ [ k ] \} , {V}_{max} \} \qquad ( 19 )$$

When the algorithm converges (i.e., when consecutive values of the velocity threshold are substantially equal), Δ[k]=0, leading to Xₘ[k]=X_{μ}[k], as desired. Changes in the arrival rate of calls and/or the distribution of users to the macro- and micro-cells are indirectly detected by an imbalance of the balancing metric which leads to larger values of Δ[k] which, in turn, triggers an update of the velocity threshold. One skilled in the art will recognize in light of the foregoing that it may be desirable to reset the value of k to 1 periodically to permit the weighted average to respond relatively quickly to changes in the call arrival rate and/or the distribution of users. For example, the value of k may be changed after a given number of update calculations (e.g., illustratively, 20 updates). Alternatively, the value of k may be reset whenever the difference in the balancing metric between the macro- and micro-layers is small.

While the foregoing discussion of equations 16-19 was applied solely to a VAS-based system, the principles of that discussion can be equally applied to a DAS-based system with equally advantageous results. In such a system, the data threshold will closely mirror that of equation 19. Specifically, the data threshold at the k-th update interval can be expressed as:

$${D}_{0} [ k ] = min \{ max \{ {D}_{min} , {D}_{0} [ k - 1 ] - \frac{{β}_{d}}{{k}^{{γ}_{d}}} Δ [ k ] \} , {D}_{max} \} \qquad ( 20 )$$

where
Δ[k]=(1−α_{d})[Xₘ[k]−X_{μ}[k]]+α_{d}·Δ[k−1] (21)
and where Δ[0]=0 and, once again, α_{d} ∈[0,1]. It will be noted that the only difference between equations 19 and 20, other than one is DAS-related and the other is VAS-related, is the change in sign between the terms in the equation. This difference is a result of the fact that, in order to increase the number of users in a micro cell layer, the data threshold D₀ should be decreased, whereas the velocity threshold should be increased to achieve the same goal. All comments in the above discussion relating to equations 16-19 apply equally to a discussion of equations 20 and 21. One skilled in the art will recognize that the tunable parameters β_{d} and γ_{d} may be chosen similarly to those chosen for the VAS-based system, as discussed above, or alternatively those parameters may be chosen differently to optimize the performance of the DAS-based system.

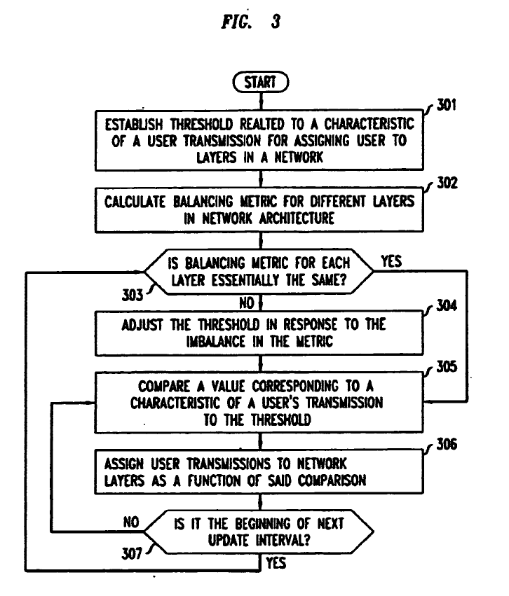

FIG. 3 shows an illustrative flow chart that represents the steps of one embodiment of a method in accordance with the assignment strategy of the present invention. One skilled in the art will recognize that this method may be carried out, for example, in a computer processor processing software instructions. Such a computer processor may reside in any network component, such as in optimization unit 204 in FIG. 2 or, alternatively, as a part of any computer hardware component within or external to the network shown in FIG. 2.

Returning to FIG. 3, at step 301, a threshold is established for at least one user transmission characteristic of an incoming call. This threshold is used to assign users to layers in a network. As discussed above, this characteristic may be, illustratively, a user's data size or velocity. Next, at step 302, a balancing metric is calculated for each layer in the network by, illustratively, the optimization unit (OU) 204 in FIG. 2. At step 303, a determination is made, once again illustratively in OU 204, as to whether the balancing metric for each layer is essentially the same. If the metric for each layer is essentially the same, it indicates that the layers are optimally balanced and, at step 305, a value corresponding to a characteristic of a user's transmission is compared to the threshold and that user is assigned to a network layer as a function of that comparison. The comparison in step 305 is, for example, made by the assignment engine (AE) 208 within the assignment unit (AU) 202 of FIG. 2.

If, at step 303, the determination is made that the balancing metric for each layer is not essentially the same, at step 304 the threshold is adjusted illustratively by the OU 204 (e.g., proportionally to the imbalance between the layers) in order to achieve an optimal balance between the layers. Once the threshold is adjusted at step 304, at step 305 the characteristic of an incoming call is compared once again at the AE 208 in the AU 201 to the adjusted threshold. After the characteristic of the call is compared to the threshold, whether that threshold was established in step 301 or adjusted in step 304, at step 306 the user transmission is assigned to a layer in the network in response to the comparison at step 305 and as discussed above.

At step 307, a determination is made as to whether it is the beginning of the next update interval. If not, the system will return to the comparison at step 305 for each incoming user, as discussed above, and will continue to assign users at step 306 to a layer in the network until, at step 307, it is determined that it is the beginning of the next update interval. When, at step 307, it is determined that it is the beginning of the next update interval, the system returns to step 303 and a determination is made as to whether the balancing metric for each layer in the network is essentially the same and the process as outlined above is followed for either adjusting the threshold (if there is an imbalance) or continuing to assign users based on the previously established threshold (if there is no imbalance).

The foregoing merely illustrates the principles of the invention. It will thus be appreciated that those skilled in the art will be able to devise various arrangements which, although not explicitly described or shown herein, embody the principles of the invention and are within its spirit and scope. Furthermore, all examples and conditional language recited herein are intended expressly to be only for pedagogical purposes to aid the reader in understanding the principles of the invention and are to be construed as being without limitation to such specifically recited examples and conditions. Moreover, all statements herein reciting aspects and embodiments of the invention, as well as specific examples thereof, are intended to encompass functional equivalents thereof.

1. A method for calculating a transmission characteristic threshold for use in assigning a user to one layer in a plurality of layers in a wireless communications network, said method comprising:
calculating a first balancing metric based on an operating characteristic of said first layer;
calculating a second balancing metric based on an operating characteristic of said second layer; and
adjusting said transmission characteristic threshold in response to the value of said first balancing metric relative to said second balancing metric.

2. The method of claim 1 further comprising the step of assigning said user to a layer in response to the value of a first user transmission characteristic of a transmission from said user relative to said adjusted transmission characteristic threshold.

3. The method of claim 1 wherein said transmission characteristic threshold is a threshold corresponding to the size of the data to be transmitted to or from said user.

4. The method of claim 3 wherein said threshold is adjusted according to the equation:
$${D}_{0} [ k ] = min \{ max \{ {D}_{min} , {D}_{0} [ k - 1 ] - \frac{{β}_{d}}{{k}^{{γ}_{d}}} Δ [ k ] \} , {D}_{max} \}$$
where D₀[k] is an optimal data size threshold at the k-th update interval of said threshold; β_{d} is an update magnitude parameter; γ_{d} is a time discounting factor; D₀[k−1] is a data size threshold used at the k−1 update interval; Δ[k] is a weighted moving average of previous values of a difference in said balancing metric between the macro-cell layer and the micro-cell layer; Dmin is the minimum data amount to be transmitted by any user in the user population; and Dₘₐₓ is a maximum possible data size corresponding to said user.

5. The method of claim 1 wherein said transmission characteristic threshold is a threshold corresponding to the velocity of said user.

6. The method of claim 5 wherein said threshold is adjusted according to the equation:
$${V}_{0} [ k ] = min \{ max \{ {V}_{min} , {V}_{0} [ k - 1 ] + \frac{{β}_{v}}{{k}^{{γ}_{v}}} Δ [ k ] \} , {V}_{max} \}$$
where V₀[k] is an optimal velocity threshold at the k-th update interval of said threshold; β_{ν} is an update magnitude parameter; γ_{ν} is a time discounting factor; V₀[k−1] is a velocity threshold used at the k−1 update interval; Δ[k] is a weighted moving average of previous values of a difference in said balancing metric between the macro-cell layer and the micro-cell layer; Vₘᵢₙ is the minimum velocity of any user in the user population; and Vₘₐₓ is the maximum velocity corresponding to said user.

7. The method of claim 1 wherein said first operating characteristic corresponds to an average number of users.

8. The method of claim 1 wherein said first operating characteristic corresponds to the expected system load as seen by said user.

9. The method of claim 7 wherein said first balancing metric is determined by the expression
$${X}_{m} = \frac{{C}_{m} - {λ}_{m} {\overline{D}}_{m}}{\sqrt{{C}_{m}}}$$
and said second balancing metric is determined by the expression
$${X}_{μ} = \frac{{C}_{μ} - {λ}_{μ} {\overline{D}}_{μ}}{\sqrt{{C}_{μ}}} .$$

10. The method of claim 8 wherein said first balancing metric is determined by the expression
$${X}_{m} = \frac{{λ}_{m} {\overline{D}}_{m}}{{C}_{m} - {λ}_{m} {\overline{D}}_{m}}$$
and the second balancing metric is determined by the expression
$$X μ = \frac{{λ}_{μ} {\overline{D}}_{μ}}{{C}_{μ} - {λ}_{μ} {\overline{D}}_{μ}} .$$

11. The method of claim 8 wherein said first balancing metric is determined by calculating the number of users in the first layer of said network and said second balancing metric is determined by calculating the number of users in said second layer of said network.

12. Apparatus for calculating a transmission characteristic threshold for use in assigning a user to one layer in a plurality of layers in a wireless communications network, said apparatus comprising:
means for calculating a first balancing metric based on an operating characteristic of said first layer;
means for calculating a second balancing metric based on an operating characteristic of said second layer; and
means for adjusting said transmission characteristic threshold in response to the value of said first balancing metric relative to said second balancing metric.

13. The apparatus of claim 12 further comprising means for assigning said user to a layer in response to the value of a first user transmission characteristic of a transmission from said user relative to said adjusted transmission characteristic threshold.

14. The apparatus of claim 12 wherein said transmission characteristic threshold is a threshold corresponding to the size of the data to be transmitted to or from said user.

15. The apparatus of claim 14 wherein said threshold is adjusted according to the equation:
$${D}_{0} [ k ] = min \{ max \{ {D}_{min} , {D}_{0} [ k - 1 ] - \frac{{β}_{d}}{{k}^{{γ}_{d}}} Δ [ k ] \} , {D}_{max} \}$$
where D₀[k] is an optimal data size threshold at the k-th update interval of said threshold; β_{d} is an update magnitude parameter; γ_{ν} d is a time discounting factor; D₀[k−1] is a data size threshold used at the k−1 update interval; Δ[k] is a weighted moving average of previous values of a difference in said balancing metric between the macro-cell layer and the micro-cell layer; Dmin is the minimum data amount to be transmitted by any user in the user population; and Dₘₐₓ is a maximum possible data size corresponding to said user.

16. The apparatus of claim 12 wherein said transmission characteristic threshold is a threshold corresponding to the velocity of said user.

17. The apparatus of claim 16 wherein said threshold is adjusted according to the equation:
$${V}_{0} [ k ] = min \{ max \{ {V}_{min} , {V}_{0} [ k - 1 ] + \frac{{β}_{v}}{{k}^{{γ}_{v}}} Δ [ k ] \} , {V}_{max} \}$$
where V₀[k] is an optimal velocity threshold at the k-th update interval of said threshold; β_{ν} is an update magnitude parameter;γ_{ν} is a time discounting factor; V₀[k−1] is a velocity threshold used at the k−1 update interval; Δ[k] is a weighted moving average of previous values of a difference in said balancing metric between the macro-cell layer and the micro-cell layer; Vₘᵢₙ is the minimum velocity of any user in the user population; and Vₘₐₓ is the maximum velocity corresponding to said user.

18. The apparatus of claim 12 wherein said first operating characteristic corresponds to an average number of users.

19. The apparatus of claim 12 wherein said first operating characteristic corresponds to the expected system load as seen by said user.

20. The apparatus of claim 18 wherein said first balancing metric is determined by the expression
$${X}_{m} = \frac{{C}_{m} - {λ}_{m} {\overline{D}}_{m}}{\sqrt{{C}_{m}}}$$
and said second balancing metric is determined by the expression
$${X}_{μ} = \frac{{C}_{μ} - {λ}_{μ} {\overline{D}}_{μ}}{\sqrt{{C}_{μ}}} .$$

21. The apparatus of claim 18 wherein said first balancing metric is determined by the expression
$${X}_{m} = \frac{{λ}_{m} {\overline{D}}_{m}}{{C}_{m} - {λ}_{m} {\overline{D}}_{m}}$$
and the second balancing metric is determined by the expression
$$X μ = \frac{{λ}_{μ} {\overline{D}}_{μ}}{{C}_{μ} - {λ}_{μ} {\overline{D}}_{μ}} .$$

22. The apparatus of claim 18 wherein said first balancing metric is determined by calculating the number of users in the first layer of said network and said second balancing metric is determined by calculating the number of users in said second layer of said network.

23. An assignment manager for assigning a user to one layer in a plurality of layers in a wireless communications network, said assignment manager comprising:
a first circuit for calculating a first balancing metric based on an operating characteristic of said first layer;
a second circuit for calculating a second balancing metric based on an operating characteristic of said second layer; and
a third circuit for adjusting a transmission characteristic threshold in response to the value of said first balancing metric relative to said second balancing metric.

24. The assignment manager of claim 23 wherein said first circuit, said second circuit, said third circuit and said fourth circuit are the same circuit.

25. The assignment manager of claim 23 further comprising a fourth circuit for assigning said user to a layer in response to the value of a first user transmission characteristic of a transmission from said user relative to said adjusted transmission characteristic threshold.

26. The assignment manager of claim 23 wherein said first circuit, said second circuit, said third circuit and said fourth circuit are the same circuit.

27. The assignment manager of claim 23 wherein said transmission characteristic threshold is a threshold corresponding to the size of the data to be transmitted to or from said user.

28. The assignment manager of claim 27 wherein said threshold is adjusted according to the equation:
$${D}_{0} [ k ] = min \{ max \{ {D}_{min} , {D}_{0} [ k - 1 ] - \frac{{β}_{d}}{{k}^{{γ}_{d}}} Δ [ k ] \} , {D}_{max} \}$$
where D₀[k] is an optimal data size threshold at the k-th update interval of said threshold; β_{d} is an update magnitude parameter; γ_{d} is a time discounting factor; D₀[k−1] is a data size threshold used at the k−1 update interval; Δ[k] is a weighted moving average of previous values of a difference in said balancing metric between the macro-cell layer and the micro-cell layer; Dmin is the minimum data amount to be transmitted by any user in the user population; and Dₘₐₓ is a maximum possible data size corresponding to said user.

29. The assignment manager of claim 23 wherein said transmission characteristic threshold is a threshold corresponding to the velocity of said user.

30. The assignment manager of claim 29 wherein said threshold is adjusted according to the equation:
$${V}_{0} [ k ] = min \{ max \{ {V}_{min} , {V}_{0} [ k - 1 ] + \frac{{β}_{v}}{{k}^{{γ}_{v}}} Δ [ k ] \} , {V}_{max} \}$$
where V₀[k] is an optimal velocity threshold at the k-th update interval of said threshold; β_{ν} is an update magnitude parameter; γ_{ν} is a time discounting factor; V₀[k−1] is a velocity threshold used at the k−1 update interval; Δ[k] is a weighted moving average of previous values of a difference in said balancing metric between the macro-cell layer and the micro-cell layer; Vₘᵢₙ is the minimum velocity of any user in the user population; and Vₘₐₓ is the maximum velocity corresponding to said user.

31. The assignment manager of claim 23 wherein said first operating characteristic corresponds to an average number of users.

32. The assignment manager of claim 23 wherein said first operating characteristic corresponds to the expected system load as seen by said user.

33. The assignment manager of claim 31 wherein said first balancing metric is determined by the expression
$${X}_{m} = \frac{{C}_{m} - {λ}_{m} {\overline{D}}_{m}}{\sqrt{{C}_{m}}}$$
and said second balancing metric is determined by the expression
$${X}_{μ} = \frac{{C}_{μ} - {λ}_{μ} {\overline{D}}_{μ}}{\sqrt{{C}_{μ}}} .$$

34. The assignment manager of claim 32 wherein said first balancing metric is determined by the expression
$${X}_{m} = \frac{{λ}_{m} {\overline{D}}_{m}}{{C}_{m} - {λ}_{m} {\overline{D}}_{m}}$$
and the second balancing metric is determined by the expression
$${X}_{μ} = \frac{{λ}_{μ} {\overline{D}}_{μ}}{{C}_{μ} - {λ}_{μ} {\overline{D}}_{μ}} .$$

35. The assignment manager of claim 32 wherein said first balancing metric is determined by calculating the number of users in the first layer of said network and said second balancing metric is determined by calculating the number of users in said second layer of said network.

36. The assignment manager of claim 23 wherein said first circuit, said second circuit, said third circuit and said fourth circuit are the same circuit.
